(19) United States
(12) Patent Application Publication
(10) Pub. No.: US 2019/0258629 A1
(43) Pub. Date: Aug. 22, 2019

(54) DATA MINING METHOD BASED ON MIXED-TYPE DATA

(71) Applicant: Wisers Information Limited, Wan Chai, Hong Kong (CN)

(72) Inventors: Liuyang ZHOU, Wan Chai, Hong Kong (CN); Chao HE, Happy Valley, Hong Kong (CN); Wing Ki LEUNG, Wan Chai, Hong Kong (CN)

(21) Appl. No.: 15/779,780

(22) PCT Filed: Nov. 17, 2016
(86) PCT No.: PCT/CN2016/106259

§ 371 Date: May 29, 2018

(30) Foreign Application Priority Data
Dec. 1, 2015 (CN) 201510867137.1

(51) Int. Cl. G06F 16/2458; G06F 16/55; G06F 17/27

(52) U.S. Cl. CPC G06F 16/2465; G06F 17/2745; G06F 16/55

(57) ABSTRACT

The data mining method disclosed in the present invention is used for mining mixed-type data by mining subject information from image data and mining scene information or sentiment information from text data and categorizing and aggregating the obtained information, so as to obtain the correlation between specific subject information and specific scene information or sentiment information. Since the present invention is based on mixed-type data, it is possible to effectively avoid information loss caused by mining only one type of data. Meanwhile, it is possible to accurately obtain information correlation and reduce interference of irrelevant information.

### TECHNICAL FIELD

The present invention relates to mining of a plurality of mixed-type data. More specifically, the present invention relates to a method of mining information correlation from mixed-type data.

### BACKGROUND ART

With the arrival of Big Data era, finding effective information in massive data becomes an important subject, which especially relates to mining information correlation. Social media platforms (such as Twitter, Weibo, WeChat, Facebook, Instagram and so on) have become a new media carrier of user-generated contents. Internet users usually employ a plurality of mixed-type data, such as data combining images and text, for information dissemination on social media platforms.

Existing technologies for analyzing user-generated contents generally focus only on text data analysis. For example, information is extracted from the text using LDA (Latent Dirichlet Allocation) or PLSA (Probabilistic Latent Dirichlet Allocation) model and the like. This may solve the “semantic gap” between the literal meaning of a text and its high-level semantics to some extent, so as to find information correlation hidden under the literal meaning of the text. However, information may exist in other type of data. For example, for social media, besides text data, large amount of information often exists in image data or video data. Therefore, performing data mining merely in text data may cause information loss.

### SUMMARY

Regarding the above-mentioned problem, the purpose of the present invention is to provide a data mining method for mining information in mixed-type data and obtaining information correlation.

According to a first aspect of the present invention, a data mining method for mining mixed-type data is provided. The mixed-type data include image data and text data, wherein the image data contains subject information and the text data contains scene information or sentiment information. The data mining method comprises the following steps: a. creating a subject knowledge base, and creating a scene knowledge base or sentiment knowledge base; b. obtaining a plurality of data units, wherein at least some of the data units comprise image data and text data, wherein the image data contains subject information and the text data contains scene information or sentiment information; c. decomposing each of the data units into image data and text data; d. based on the subject knowledge base, for the image data of each data unit, identifying the subject information from the image data using an automatic image identification method; e. categorizing the data units based on the subject information, so as to form at least one subject domain, wherein each of the subject domain corresponds to a plurality of data units; f. based on the scene knowledge base or sentiment knowledge base, for the text data of each data unit in each subject domain, identifying the scene information or sentiment information from the text data using an automated text analysis method, so as to obtain at least one scene domain or sentiment domain corresponding to specific subject information; g. categorizing the elements in each scene domain or sentiment domain based on scene information or sentiment information, so as to obtain a plurality of specific domains, wherein each of the specific domains contains the same subject information and the same scene information, or contains the same subject information and the same sentiment information.

Preferably, the data unit is provided with a data identifier, wherein image data and text data belonging to the same data unit have the same data identifier and are associated with each other via the data identifier.

Preferably, the automatic image identification method comprises the following steps: extracting identification features of an image data to be identified; inputting the identification features of the image data into the subject knowledge base to perform computation, so as to determine whether the specific subject information is contained.

Preferably, the automatic text analysis method comprises the following steps: extracting analysis features of a text data; inputting the analysis features of the text data into the scene knowledge base or sentiment knowledge base to perform computation, so as to determine whether the specific scene information or sentiment information is contained.

Preferably, the automatic text analysis method comprises the following steps: extracting keywords from a target text; inputting the keywords into the scene knowledge base or sentiment knowledge base, and determine whether the target text contains the specific scene information or sentiment information based on syntactic rules.

Preferably, the data mining method further comprises the following step: h. ordering all the specific domains containing the same subject information according to the number of elements therein.

Preferably, the data mining method further comprises the following step: h. ordering all the specific domains containing the same scene information or sentiment information according to the number of elements therein.

Preferably, the data mining method further comprises the following step: h. filtering all the specific domains based on user-defined filtering criteria, and ordering the specific domains after filtering according to the number of elements therein.

According to a second aspect of the present invention, a data mining method for mining mixed-type data is provided. The data mining method comprises the following steps: a. creating a subject knowledge base, and creating a scene knowledge base or sentiment knowledge base; b. obtaining a plurality of data units, wherein at least some of the data units comprise image data and text data, wherein the image data contains subject information and the text data contains scene information or sentiment information; c. decomposing each of the data units into image data and text data; d. based on the subject knowledge base, for the image data of each data unit, identifying the subject information from the image data using an automatic image identification method; e. based on the scene knowledge base or sentiment knowledge base, for the text data of each data unit, identifying the scene information or sentiment information from the text data using an automated text analysis method; f. categorizing the subject information, so as to form at least one subject domain; g. for each subject domain, finding the scene information or sentiment information of the data unit corresponding to each subject information, so as to obtain a scene domain or sentiment domain corresponding to the specific subject information; h. categorizing elements in each of the scene domains or sentiment domains based on scene information or sentiment information, so as to obtain a plurality of specific domains, wherein each of the specific domains contains the same subject information and the same scene information, or contains the same subject information and the same sentiment information.

According to a third aspect of the present invention, a data mining method for mining mixed-type data is provided. The mixed-type data include image data and text data, wherein the image data contains subject information and the text data contains scene information or sentiment information. The data mining method comprises the following steps: a. creating a subject knowledge base, and creating a scene knowledge base or sentiment knowledge base; b. obtaining a plurality of data units, wherein at least some of the data units comprise image data and text data, wherein the image data contains subject information and the text data contains scene information or sentiment information; c. decomposing each of the data units into image data and text data; d. based on the scene knowledge base or sentiment knowledge base, for the text data of each data unit, identifying the scene information or sentiment information from the text data using an automated text analysis method; e. categorizing the data units based on scene information or sentiment information, so as to form at least one scene domain or sentiment domain, wherein each of the scene domain or sentiment domain corresponds to a plurality of data units; f. based on the subject knowledge base, for the image data of each data unit in each scene domain or sentiment domain, identifying the subject information from the image data using an automated image identification method, so as to obtain at least one subject domain corresponding to the specific scene information or sentiment information; g. categorizing the elements in each of the subject domains based on subject information, so as to obtain a plurality of specific domains, wherein each of the specific domains contains the same subject information and the same scene information, or contains the same subject information and the same sentiment information.

According to a fourth aspect of the present invention, a data mining method for mining mixed-type data is provided. The data mining method comprises the following steps: a. creating a subject knowledge base, and creating a scene knowledge base or sentiment knowledge base; b. obtaining a plurality of data units, wherein at least some of the data units comprise image data and text data, wherein the image data contains subject information and the text data contains scene information or sentiment information; c. decomposing each of the data units into image data and text data; d. based on the subject knowledge base, for the image data of each data unit, identifying the subject information from the image data using an automatic image identification method; e. based on the scene knowledge base or sentiment knowledge base, for the text data of each data unit, identifying the scene information or sentiment information from the text data using an automated text analysis method; f. categorizing the scene information or sentiment information, so as to form at least one scene domain or sentiment domain; g. for each scene domain or sentiment domain, finding the subject information of the data unit corresponding to each scene information or sentiment information, so as to obtain a subject domain corresponding to the specific scene information or sentiment information; h. categorizing each of the subject domains based on subject information, so as to obtain a plurality of specific domains, wherein each of the specific domains contains the same subject information and the same scene information, or contains the same subject information and the same sentiment information.

Compared with prior art, the present invention at least has the following advantages:

In the present invention, by mining subject information from image data and mining scene information or sentiment information from text data, and categorizing and aggregating the obtained information, correlation between specific subject information and specific scene information or sentiment information can be obtained. Since the present invention mines information in mixed-type data, it effectively avoids information loss caused by mining only a single type of data. Meanwhile, it is possible to accurately obtain information correlation and reduce interference of irrelevant information.

### BRIEF DESCRIPTION OF THE DRAWINGS

Now, a detailed description of the present invention will be provided with reference to the accompanying drawings.

FIG. 1 is a schematic diagram after obtaining mixed-type data units according to the present invention;

FIG. 2a is a schematic diagram showing decomposition of some of the data units and identification of subject information using automatic image identification method according to a first embodiment of the present invention;

FIG. 2b is a schematic diagram showing decomposition of other data units and identification of subject information using an automatic image identification method according to the first embodiment of the present invention;

FIG. 3 is a schematic diagram of several subject domains of the first embodiment of the present invention;

FIG. 4 is a schematic diagram showing identification of scene information from the text data of each data unit in the subject domain of the first embodiment of the present invention using an automatic text analysis method;

FIG. 5 is a schematic diagram of several scene domains of the present invention;

FIG. 6 is a schematic diagram of several specific domains of the present invention;

FIG. 7 is a flow chart showing the process of a data mining method according to the first embodiment of the present invention;

FIG. 8a is a flow chart showing the process of training an image identification model in an automated image identification method of the present invention;

FIG. 8b is a flow chart showing the process of identifying subject information using the image identification model in the automated image identification method according to the present invention;

FIG. 9a is a flow chart showing the process of training a text analysis model in an automated text analysis method according to the present invention;

FIG. 9b is a flow chart showing the process of identifying scene information using the text analysis model in the automatic text analysis method according to the present invention;

FIG. 10 is a flow chart showing the process of an automatic text analysis method according to another embodiment of the present invention;

FIG. 11a is a schematic diagram showing decomposition of some of the data units and identification of subject information using an automatic image identification method, as well as identification of scene information using an automatic text analysis method according to a second embodiment of the present invention;

FIG. 11b is a schematic diagram showing decomposition of other data units and identification of subject information using an automatic image identification, as well as identification of scene information using an automatic text analysis method according to the second embodiment of method of the present invention;

FIG. 12 is a schematic diagram of several subject domains of the second embodiment of the present invention;

FIG. 13 is a flow chart showing the process of a data mining method according to the second embodiment of the present invention;

FIG. 14 is a block diagram showing a hardware system corresponding to the data mining method of the present invention;

FIG. 15 is a flow chart showing the process of a data mining method according to a third embodiment of the present invention;

FIG. 16 is a flow chart showing the process of a data mining method according to a fourth embodiment of the present invention.

### EMBODIMENTS OF THE INVENTION

Now, a detailed description of the present invention will be provided with reference to the accompanying drawings.

### Embodiment 1

According to the method of the present embodiment, subject information and scene information may be identified from a large amount of data, therefore obtaining correlation between specific subject information and specific scene information. Specifically, subject usually refers to product, people or brand, and scene usually refers to location or occasion, such as celebrating birthday, eating hot pot, KTV and the like. It should be noted that the present embodiment illustrates the process of identifying scene information from data and mining correlation between scene information and subject information. With methods similar to that of identifying scene information and mining correlation between scene information and subject information, sentiment information may also be identified from data, therefore obtaining correlation between sentiment information and subject information. Sentiment information refers to opinions on certain things, such as preference, disgust, suspicious and so on. Sentiment information may also be rated, so as to express the degree of the corresponding sentiment.

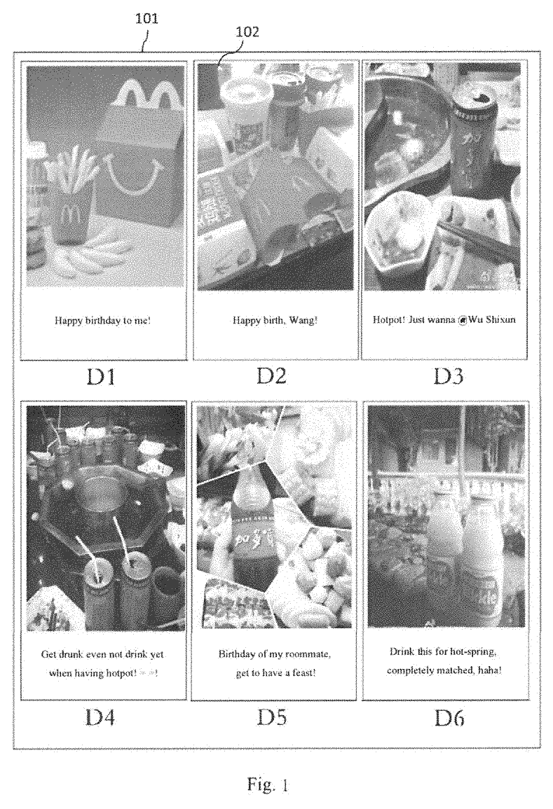

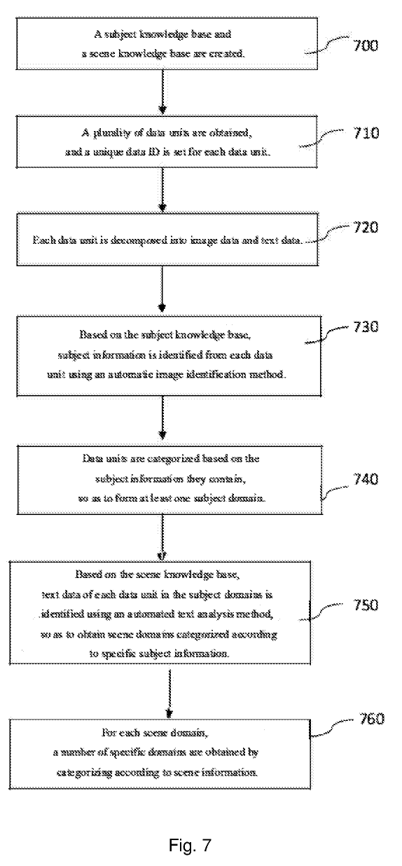

FIGS. 1-6 illustrate the key steps or the result of the process of the present embodiment. FIG. 7 is a flow chart showing the process of a data mining method according to the present embodiment. Now, the data mining method of the present embodiment will be described below in correspondence with FIGS. 1-7.

As shown in FIG. 7, first, in Step 700, a subject knowledge base (not shown) and a scene knowledge base (not shown) are created. When identification of sentiment information is needed, a sentiment knowledge base is also created.

The subject knowledge base includes a plurality of subject information. Each specific subject information includes: the name of the subject (for example: McDonald's, Coke, Yao Ming), a unique subject identifier corresponding to the specific subject information (i.e., subject ID), auxiliary attributes of the specific subject (for example, the industry, company, region that the subject belongs to). The subject knowledge base further includes an image identification model. Based on the image identification model in the subject knowledge base, subject information can be identified from image data. The training and application of the image identification model will be described in detail as below.

The scene knowledge base includes a plurality of scene information. Each specific scene information includes: a topic label of the scene (such as celebrating birthday, eating hot pot), a unique scene identifier corresponding to the specific scene information (i.e., scene ID). The scene knowledge base also includes a text analysis model. Based on the text analysis model in the scene knowledge base, scene information can be identified from text data. The training and application of the text analysis model will be described in detail as below.

The creation of the sentiment knowledge base is similar to that of the scene knowledge base.

Then, in Step 710, a plurality of data units 102 are obtained. The plurality of data units 102 may be captured from the Internet. For example, data may be collected from social network platforms. Alternatively, data may also be provided by the user. After obtaining the plurality of data units 102, a data domain 101 as shown in FIG. 1 is formed.

Specifically, take collecting data from social network platforms as an example, data units 102 may be captured by calling an application programming interface (API) provided by an open platform. Each individually published article or post may be regarded as a data unit 102. Some data units 102 may include a plurality of data types, such as text data, image data, or video data (i.e., mixed-type data). Such mixed-type data captures subject information and scene information. In addition, data units 102 also include auxiliary information (not shown), such as publisher information, publication time, publication location and the like. Data unit 102 may further include information for identifying corresponding relationship of different data types in a same data unit 102. In the present embodiment, each data unit 102 is identified by a unique data identifier (i.e., data ID). Using the data ID, mixed-type data may be quickly and easily correlated in subsequent operations, so as to be quickly located.

It is easy to understand that other known methods may be adopted for capturing data, such as through web crawler programs.

As shown in FIG. 1, in the present embodiment, data domain 101 illustratively includes six data units 102, each of which includes image data and text data. It is easy to understand that in actual use, some of the data in data domain 101 may include only one data type, but at least part of the data includes two data types. Subject information is captured in image data, and scene information is captured in text data. Respective data ID is provided for each of the six data units 102, namely, D1, D2, D3, D4, D5 and D6.

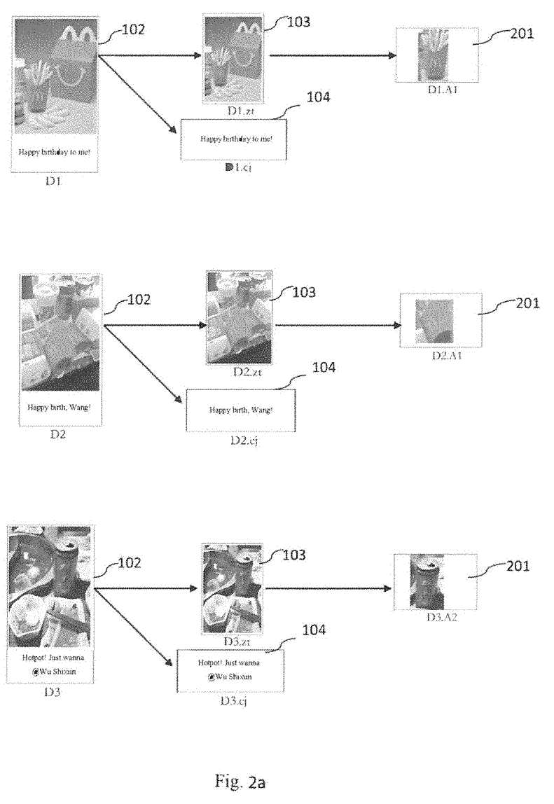

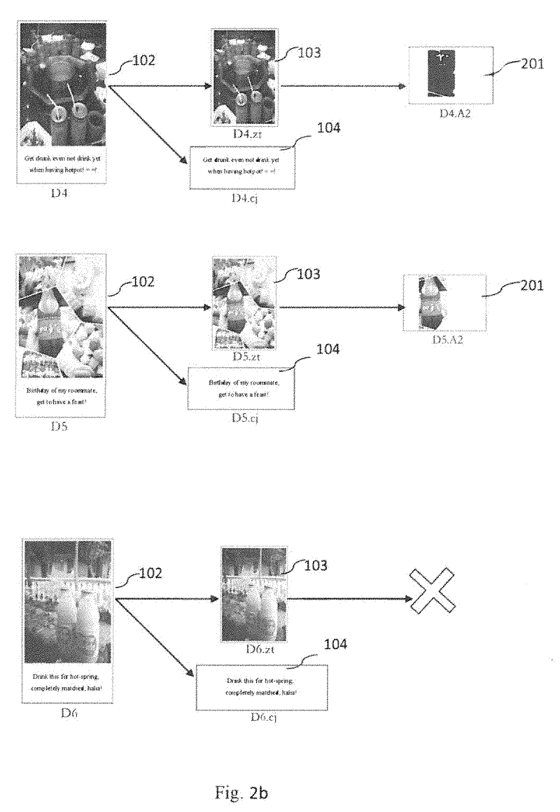

In Step 720, each data unit 102 is decomposed into image data 103 and text data 104. The image data 103 and the text data 104 decomposed from the same data unit 102 will have the same data ID. Moreover, by providing different identifier suffixes, the image data and the text data may be distinguished. For example, data ID with suffix “.zt” represents image data, while data ID with suffix “.cj” represents text data. Since different types of data have different formats thus different encoding methods, different types of data can be distinguished intrinsically by API or by parsing webpages' markup codes, etc. FIGS. 2a and 2b show the result after decomposition of the six data units 102 of the present embodiment. Different processing methods are adopted for different types of data, so as to decompose the data unit 102 to facilitate subsequent processing.

Still with reference to FIGS. 2a and 2b, in Step 730, based on an image identification model of the subject knowledge base, subject information 201 may be identified from the image data 103 using an automatic image identification method.

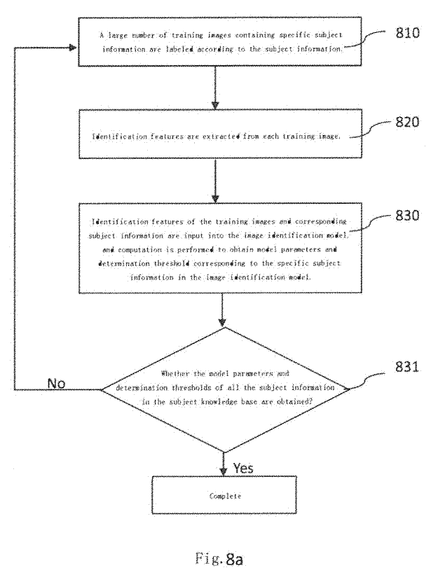

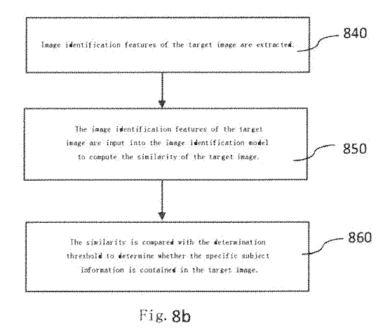

Specifically, in the present embodiment, as shown in FIG. 8b, the automated image identification method includes identifying subject information 201 from the image data 103 using the image identification model. Before recognizing subject information 201 using the image identification model, it is necessary to train the image identification model according to the process shown in FIG. 8a.

Now, the training method of the image identification model will be described below.

As shown in FIG. 8a, first, in Step 810, a large number of images corresponding to a specific subject information are selected as training images, and the images are labeled. For example, the subject information contained in the image and the specific location of the subject information in the image are annotated.

Next, in Step 820, the image identification features at the location of the subject information are extracted from each training image. The image identification features include a series of digital representation of color feature, texture feature, shape feature, spatial relationship feature for describing the image. Any solution for extracting image identification features known in the art may be adopted, such as feature extraction methods based on local points of interest (e.g., MSER, SIFT, SURF, ASIFT, BRICK, ORB), bag of words feature extraction methods based on visual dictionary, or automatic feature learning methods based on deep learning technology.

Next, in Step 830, the image identification features of the training images and the specific subject information are input into the image identification model. Computation is performed using statistical method or machine learning method, so as to learn model parameters and determination threshold corresponding to the specific subject information in the image identification model. The above method is used for each subject information in the subject knowledge base. More specifically, as shown in Step 831, it is determined that whether the model parameters and determination thresholds of all the subject information in the subject knowledge base are obtained. If not, the process goes back to Step 810 and the whole process is repeated. If yes, the training process of the image identification model is completed, so that the image identification model contains the model parameters and determination thresholds corresponding to all the subject information in the subject knowledge base. When a new subject information is added into the subject knowledge base, the above steps are performed, so that model parameters and determination threshold corresponding to the new subject information will be added into the image identification model.

FIG. 8b shows identification of subject information 201 from the image data 103 using the image identification model. In Step 840, the image identification features of the image data to be processed (i.e., the target image) are extracted. Here, the method for extracting image identification features of the target image should be the same as that described in Step 820, so as to reduce identification error.

In Step 850, the image identification features of the target image are input into the image identification model to compute the similarity or probability between the target image and each specific subject information. Depending on specific modeling method, direct matching method based on image identification features (e.g., kernel similarity, second normal form similarity, kernel cross similarity, etc.) may be used for similarity or probability calculation, so as to calculate the similarity between the input image identification feature and each specific subject information. A pre-trained machine learning model may also be used to calculate the probability of the image containing a certain subject information.

In Step 860, the similarity or probability obtained in Step 850 is compared with the determination threshold corresponding to the specific subject in the image identification model, so as to determine whether the specific subject information is contained in the target image data.

As shown in FIGS. 2a and 2b, in the present embodiment, based on the subject knowledge base, subject information 201 is identified from the image data 103 using the above-described automatic image identification method (i.e., Step 730). It should be noted that to facilitate understanding, the subject information 201 in FIGS. 2a and 2b illustratively uses a schematic image thereof. In actual use, a data ID and a specific subject identifier (i.e., subject ID) are usually used to identify the extracted subject information. For example, D1.A1 indicates that the subject information is from data unit D1, and the identified subject ID is A1, which corresponds to the subject name “McDonald's” in the subject knowledge base. The same subject information will have the same subject ID. For example, as shown in the examples in FIGS. 2a and 2b, the image data in data units D1 and D2 contain the same subject information “McDonald's”, whose corresponding subject ID is A1. The image data in data units D3, D4, and D5 contain the same subject information “JiaDuoBao”, whose corresponding subject ID is A2. Since the image data in data unit D6 is identified having no matching subject information by the automated image identification method, it is represented by “x” in FIG. 2b.

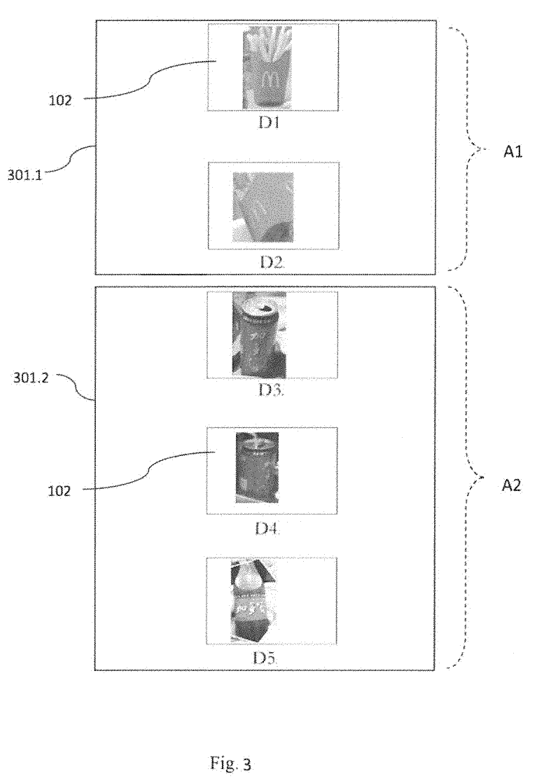

Then, in Step 740, data units 102 are categorized based on the subject information 201 they contain, so as to form at least one subject domain 301.1, 301.2. FIG. 3 illustratively shows the result of a plurality of subject domains 301.1, 301.2 formed after performing Step 740. Since data unit D1 and data unit D2 have the same subject information A1, they are categorized into the same subject domain 301.1. Since data unit D3, data unit D4, data unit D5 have the same subject information A2, they are categorized into another subject domain 301.2. Since no subject information is identified in data unit D6, it is not categorized into any specific subject domain.

It is to be noted that in the present embodiment, subject information is used to categorize data units. Therefore, although FIG. 3 only illustratively shows the subject information 201, the elements in subject domains 301.1 and 301.2 are in fact the data units 102 corresponding to the subject information 201.

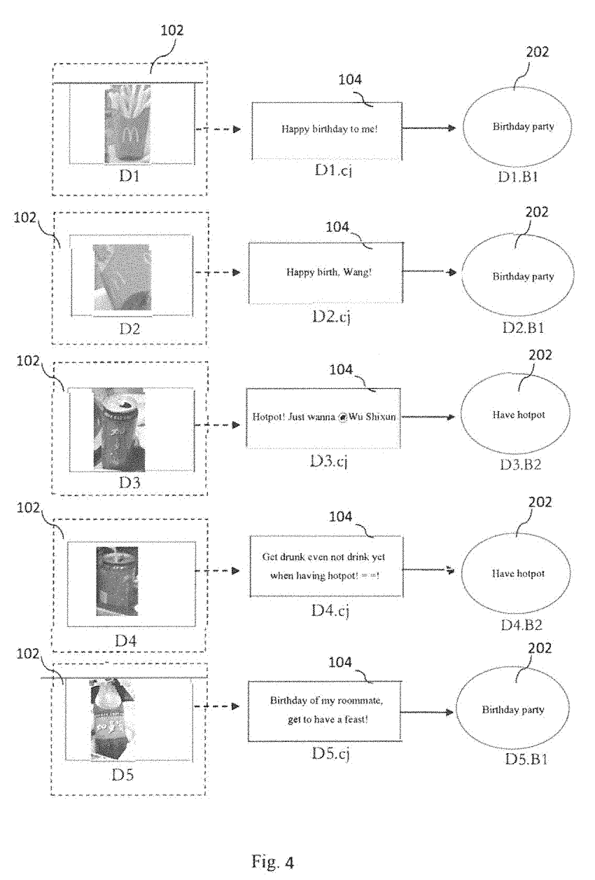

Next, as shown in Step 750 and in FIG. 4, in the present embodiment, based on the scene knowledge base, text data 104 of each data unit 102 in the subject domains 301.1 and 301.2 formed in Step 740 is identified using an automated text analysis method, so as to obtain scene information 202.

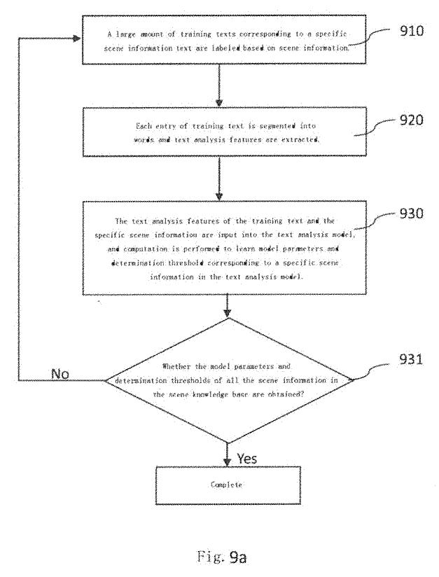

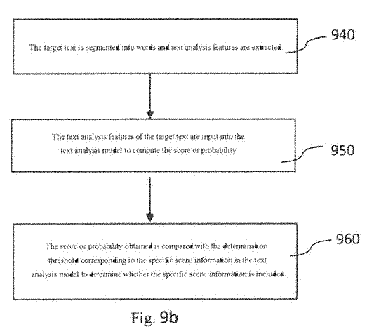

Specifically, the automated text analysis method includes identifying scene information 202 from the text data 104 using a text analysis model. Before identifying scene information 202 using the text analysis model, it is necessary to train the text analysis model according to the process shown in FIG. 9a.

FIG. 9a is a flow chart showing the process of training a text analysis model in an automated text analysis method. In Step 910, a large amount of text corresponding to a specific scene information is selected as training data, and the text is labeled based on scene information (i.e., topic label). For example, the scene information contained in the text is annotated.

Then, in Step 920, each training text is segmented into words, and text analysis features are extracted from the training text. The text analysis features include a series of word expressions for describing the topic label. Any solution known in the art for extracting and representing text analysis features may be adopted, for example, TF-IDF features based on word distribution, n-gram features based on co-occurring word combinations, syntactic features obtained from part-of-speech analysis or syntactic dependency analysis, or features automatically learned using deep learning technology. It should be noted that certain text analysis features, such as n-gram features, can be extracted directly without word segmentation.

Then, in Step 930, the text analysis features of the training text and the specific scene information are input into the text analysis model. Computation is performed using statistical method or machine learning method, so as to learn model parameters and determination threshold corresponding to a specific scene information in the text analysis model. The above method is used for each scene information in the scene knowledge base. More specifically, as described in Step 931, it is determined that whether the model parameters and determination thresholds of all the scene information in the scene knowledge base are obtained. If not, the process goes back to Step 910 and the whole process is repeated. If yes, the text analysis model is completed, so that the text analysis model contains the model parameters and determination thresholds corresponding to all the scene information in the scene knowledge base. When a new scene information is added into the scene knowledge base, the above steps are performed, so that the model parameters and determination threshold corresponding to the new scene information may be added into the text analysis model.

FIG. 9b is a flow chart showing the process of identification of scene information using the text analysis model according to this embodiment. In Step 940, the text data to be analyzed (i.e., the target text) is segmented into words, and text analysis features are extracted from the target text. Here, the method for word segmentation and extracting the text analysis features should be the same as that described in Step 920, so as to reduce analysis error.

In Step 950, the text analysis features of the target text are input into the text analysis model to compute the score or probability of the target text with respect to each specific scene information.

In Step 960, the score or probability obtained in Step 950 is compared with the determination threshold corresponding to the specific scene information in the text analysis model, so as to determine whether the specific scene information 202 is included in the target text data.

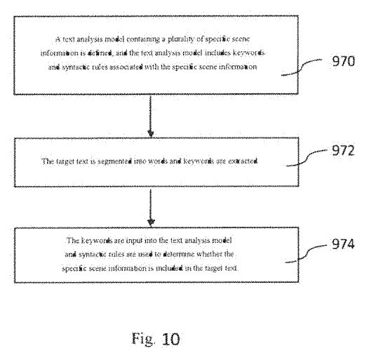

Regarding the automatic text analysis method, the method shown in FIG. 10 may also be used in other embodiments.

Specifically, in Step 970, first, a text analysis model containing a plurality of specific scene information is defined. The text analysis model includes keywords and syntactic rules associated with the specific scene information.

In Step 972, the target text is segmented into words and keywords are extracted. In some extraction methods, the keywords may be extracted directly without performing word segmentation.

Then, in Step 974, the keywords are input into the text analysis model. Syntactic rules are used for determining the specific scene information that the target text corresponds to, so as to obtain the scene information included in the target text.

In other embodiments, the two automatic text analysis methods described above may also be combined. In other words, the constructed text analysis model may include both text analysis features and keywords.

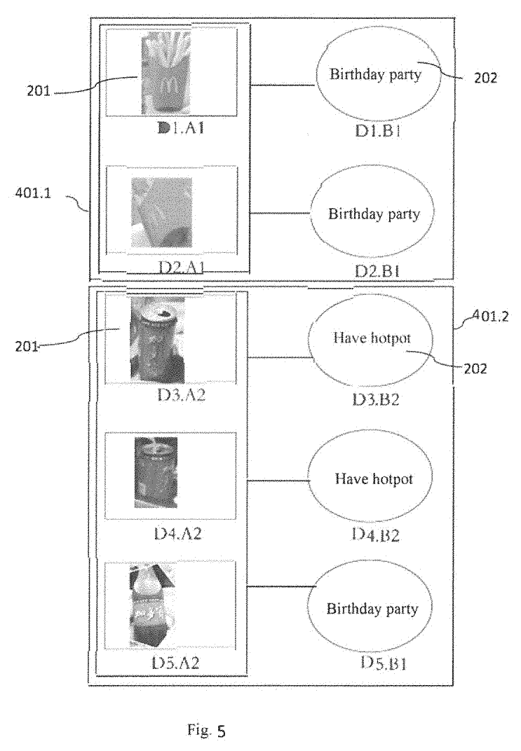

It is to be noted that, to facilitate understanding, the scene information 202 in FIG. 4 illustratively uses the topic label for describing this specific scene information 202. In actual use, a data ID and a specific scene identifier (i.e., scene ID) are often used for identifying the extracted scene information. For example, D1.B1 indicates that the subject information is from data unit D1, and the identified scene ID is B1, whose corresponding topic label in the scene knowledge base is “celebrating birthday”. The same scene information will have the same scene ID. For example, as shown in the example of FIG. 4, the text data in data units D1, D2 and D5 contain the same scene information “celebrating birthday”, whose corresponding scene ID is B1. The text data in data units D3 and D4 contain the same scene information “eating hotpot”, whose corresponding scene ID is B2. Since the subject information 201 in each subject domain 301.1, 301.2 is the same, after identifying the scene information 202, scene domains 401.1 and 401.2 categorized according to the specific subject information 201 as shown in FIG. 5 are obtained. Each scene domain 401.1, 401.2 has a plurality of elements consisting of interrelated specific subject information 201 and specific scene information 202. It should be noted that the elements in the scene domains 401.1 and 401.2 are no longer data units 102, but are elements consisting of interrelated subject information 201 and the scene information 202.

When sentiment information needs to be identified, similar method as that used for identifying scene information from text data may be adopted. Based on the sentiment knowledge base, sentiment information may be identified using an automatic text analysis method. At least one sentiment domain corresponding to specific subject information may then be obtained.

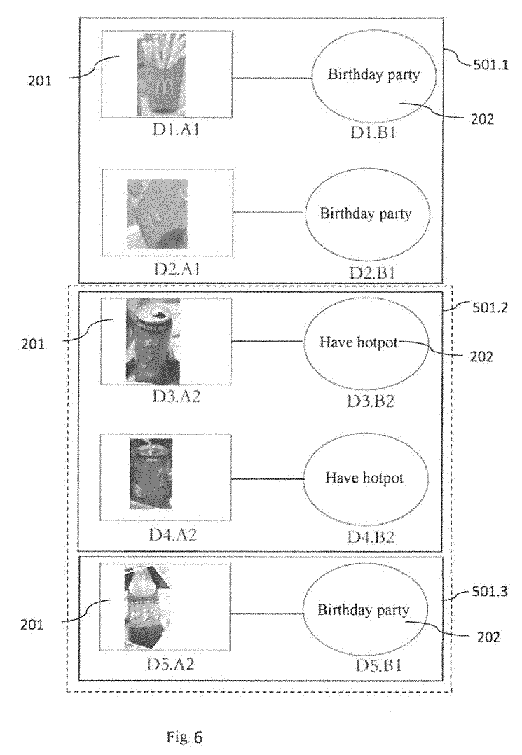

As shown in Step 760 and FIG. 6, the elements in each scene domain 401.1, 401.2 is categorized based on scene information 202, so as to obtain a plurality of specific domains 501.1, 501.2, 501.3 having specific subject and specific scene. As shown in FIGS. 5 and 6, since the elements in the scene domain 401.1 contain only one scene ID, the elements in the specific domain 501.1 are the same as that in the scene domain 401.1, i.e., the elements have the same subject ID A1 and the same scene ID B1. The elements in scene domain may also contain a plurality of scene IDs. For example, the elements in the scene domain 401.2 of the present embodiment contain the scene IDs B1 and B2. Therefore, after Step 760, a specific domain 501.2 and a specific domain 501.3 may be obtained, wherein the elements in the specific domain 501.2 have a subject ID of A2 and a scene ID of B2, and the elements in the specific domain 501.3 have a subject ID of A2 and a scene ID of B1.

By adopting the same method, the elements in each sentiment domain are categorized based on sentiment information, so as to obtain a plurality of specific domains. The elements in each specific domain contain the same subject information and the same sentiment information.

Each specific domain 501.1, 501.2 represents the correlation of a specific subject information with a specific scene information or sentiment information. The more elements that a specific domain has, the more correlated this specific subject information is with the specific scene information or sentiment information.

The method for mining information in image data usually includes obtaining the labels of the image by classification, and describing the image using the labels. However, such method can only obtain a rough scene of the picture, but not the exact information. Moreover, such method can only mine information in image.

In contrast to the above method or the method of mining information purely in text, the present invention mines different information (subject information and scene or sentiment information) in data of various types (image data and text data), thereby effectively avoiding information loss caused by mining only one type of date, and obtaining a more accurate correlation of information.

After obtaining the specific domains 501.1, 501.2, 501.3, various applications may be easily derived according to actual needs.

Now, application examples will be described illustratively.

In one exemplary application, it aims at finding out the scene where a specific subject presents the most frequently. Specifically, first, specific domains with a specific subject ID are selected. Then, these specific domains with the same subject information are ordered according to the number of elements thereof, so as to obtain the specific domain with the largest number of elements. Then, the corresponding scene topic label may be obtained based on the scene ID corresponding to this specific domain.

For example, in order to find out the scene where “JiaDuoBao” presents the most frequently, first, the specific domains 501.2 and 501.3 are selected based on the subject ID A2 corresponding to “JiaDuoBao”. Then, the numbers of elements in the specific domains 501.2 and 501.3 are counted, and these specific domains are ordered accordingly so as to obtain the specific domain 501.2 with the most elements. Then, the subject ID A2 is obtained based on the scene ID B2 corresponding to the specific domain 501.2. In other words, the ID of the scene where “JiaDuoBao” presents the most frequently is B2, i.e., eating hotpot. Similar applications may also include ordering scenes according to the number of times that a specific subject appeared.

In another exemplary application, it aims at finding out the subjects that are most frequently presented in a specific scene. Specifically, first, specific domains with a specific scene ID are selected. Then, these specific domains with the same subject information are ordered according to the number of elements thereof, so as to obtain the specific domain with the largest number of elements. Then, the corresponding subject name may be obtained based on the subject ID corresponding to this specific domain. Similar applications may also include finding out the number of times that each subject appeared in a specific scene.

In another exemplary application, it aims at first filtering according to filtering criteria, and then finding out the subject and the scene that are most frequently presented. Here, filtering criteria may include auxiliary information in the data unit (such as publisher information, publication time, publication location), or the auxiliary attributes of subject information in the subject knowledge base (for example, the industry which it belongs to). Original data units may be filtered according to filtering criteria, so that the corresponding subject ID may be further located based on data ID. Subject information may also be filtered directly according to filtering criteria. Then, the specific domains after filtering are ordered according to the number of elements thereof, so as to obtain the subject and the scene that are most frequently presented.

Now, the hardware system architecture corresponding to the data mining method of the present embodiment will be described.

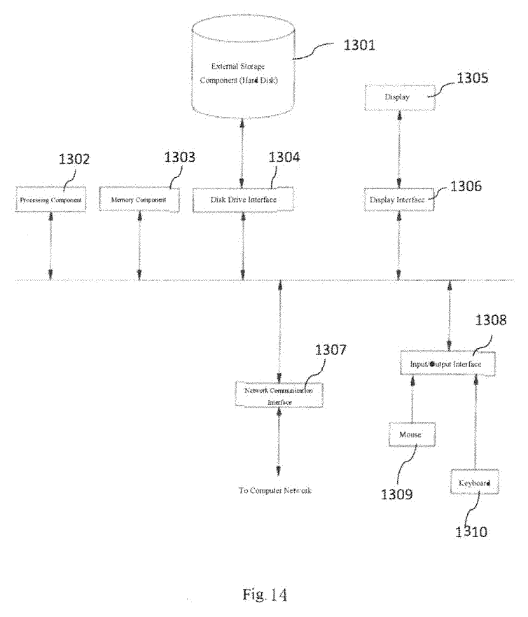

With reference to FIG. 14, the hardware system corresponding to the data mining method includes an external storage component (hard disk) 1301, a processing component 1302, a memory component 1303, a disk drive interface 1304, a display 1305, a display interface 1306, a network communication interface 1307, and an input/output interface 1308.

The data mining method of the present embodiment is stored in the memory component 1303 or the hard disk 1301 in the form of codes. The processing component 1302 executes the data mining method by reading the codes in the memory component 1303 or the hard disk 1301. The hard disk 1301 is connected to the processing component 1302 via the disk drive interface 1304. The hardware system is connected to an external computer network via the network communication interface 1307. The display 1305 is connected to the processing component 1302 via the display interface 1306 for displaying the execution result. The mouse 1309 and the keyboard 1310 are connected to other components connected to the hardware system via the input/output interface 1308, so as to be operated by an operator. Data units and various types of information involved in the data mining process are stored in the hard disk 1301.

In other embodiments, the hardware architecture may be implemented using cloud storage and cloud computing. Specifically, the codes corresponding to the data mining method, data units and various types of information involved in the data mining process, the data capture and mining process are also carried out in the cloud. The user may use client-end computer, mobile phone, or tablet to operate cloud data, or to inquire or display the mining results via the network communication interface.

### Embodiment 2

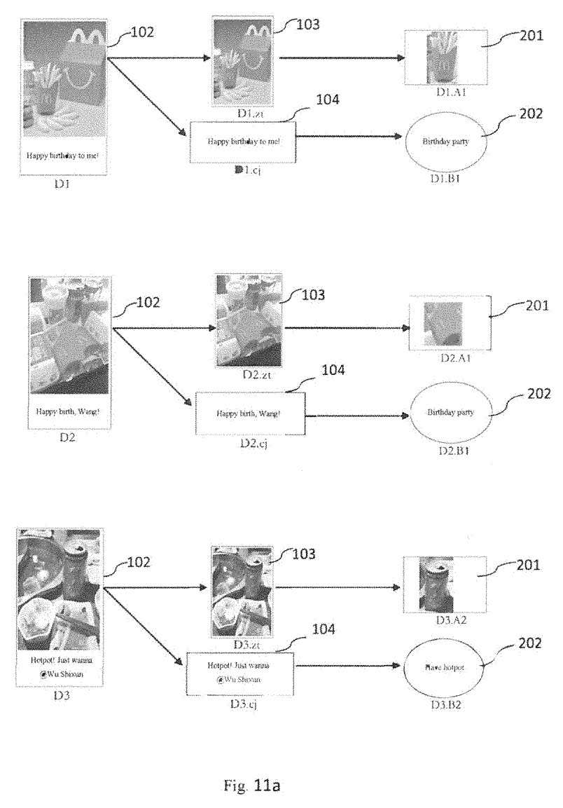

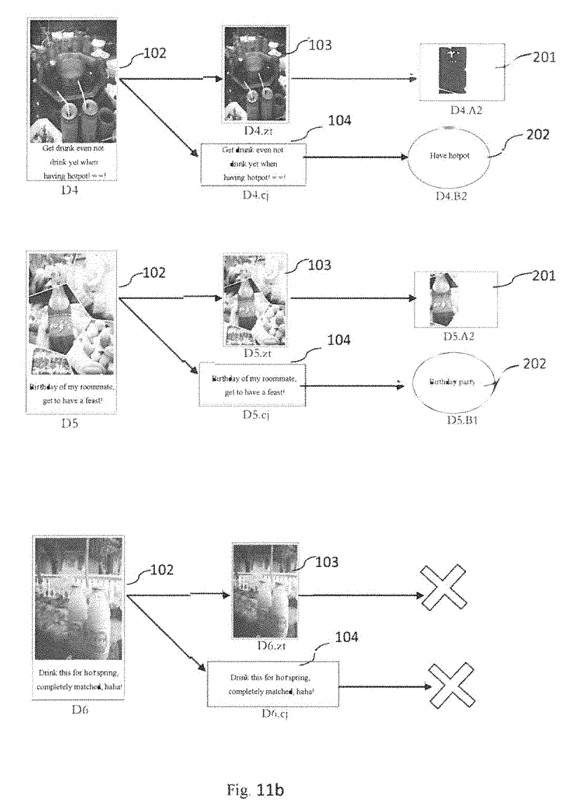

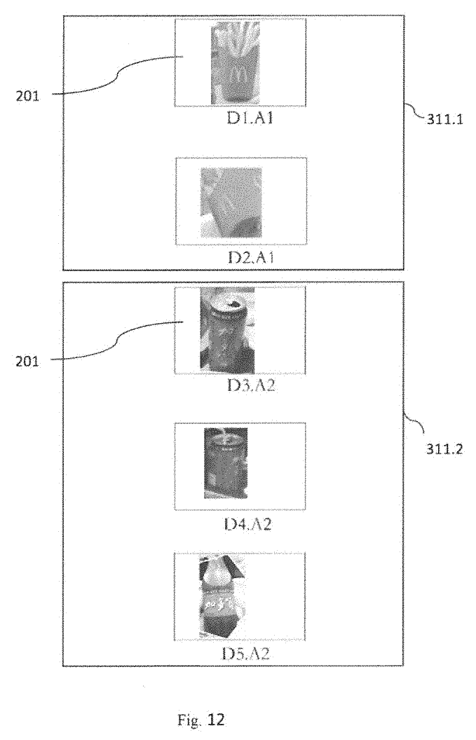

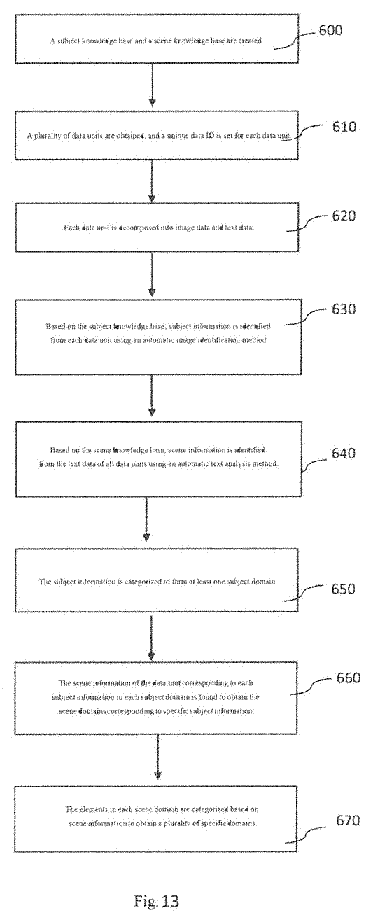

The present embodiment may also be used to identify subject information and scene information from a large amount of data, and to find out correlation between a specific subject information and a specific scene information. The method of this embodiment is partially the same as that of Embodiment 1. FIGS. 11a, 11b and 12 show the key steps of the present embodiment that are distinguished from Embodiment 1. FIG. 13 is a flow chart showing the process according to the present embodiment. Now, the data mining method of the present embodiment will be described below.

The method of this embodiment is partially the same as that of Embodiment 1. As shown in FIG. 13, Steps 600-630 of the present embodiment are identical to Steps 700-730 of Embodiment 1. As shown in FIGS. 11a, 11b and Step 640, the differences lie in that in the present embodiment, after identifying the subject information 201, based on the scene knowledge base, scene information is identified from the text data 104 of all data units 102 using an automatic text analysis method. The automatic text analysis method is the same as that of Embodiment 1, which will not be described here.

Next, with reference to FIG. 12 and Step 650, the subject information 201 is categorized to form at least one subject domain 311.1, 311.2. It should be noted that unlike Embodiment 1, the subject domains 311.1 and 311.2 of the present embodiment only include subject information 201, i.e., elements consisting of data ID and subject ID, but not original data units 102. Since no direct operation is performed on the original data units 102, the data storage amount may be reduced to a certain extent, thereby accelerating processing speed.

As shown in Step 660 and FIG. 5, the scene information 202 of the data unit corresponding to each subject information 201 in each subject domain 311.1, 311.2 may be found, so as to obtain the scene domains 401.1, 401.2 corresponding to specific subject information 201. Since each subject information 201 is identified by a data ID and a subject ID, and each scene information 202 is identified by a data ID and a subject ID, subject information 201 can be easily associated with scene information 202 based on the data ID. Each of the scene domains 401.1 and 401.2 has at least one element consisting of interrelated specific subject information 201 and specific scene information 202. As shown in Step 670 and FIG. 6, the elements in each scene domain 401.1, 401.2 are categorized based on scene information 202, so as to obtain a plurality of specific domains 501.1, 501.2, and 501.3. The detail of Step 670 is the same as that of Step 760 in Embodiment 1, which will not be described here.

The hardware system architecture of the present embodiment is similar to that of Embodiment 1, which will not be described here.

It should be noted that the method in the present embodiment may also be applied for identifying sentiment information from data, and for mining correlation between subject information and sentiment information.

### Embodiment 3

This embodiment is adjusted based on the method of Embodiment 1.

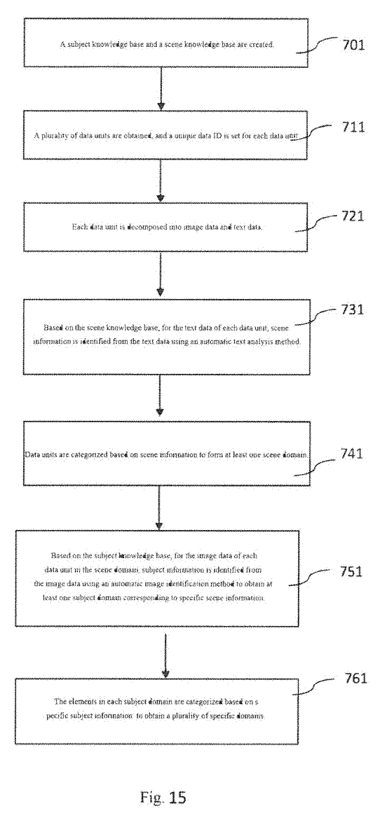

As shown in FIG. 15, Steps 701-721 of the data mining method in the present embodiment are identical to Steps 700-720 of Embodiment 1. The difference lies in that, Embodiment 1 identifies subject information 201 and categorizes data units based on subject information 201 first, and then identifies scene information 202 and performs a second categorization based on scene information 202 so as to obtain specific domains. However, in the present embodiment, scene information 202 is identified first and data units are categorized based on scene information 202 accordingly. Then, subject information 201 is identified and a second categorization based on subject information 201 is performed so as to obtain specific domains.

Specifically, in Step 731, scene information 202 is identified instead of subject information 201. That is, based on the scene knowledge base, for the text data 104 of each data unit 102, scene information 202 is identified from the text data 104 using an automatic text analysis method. In Step 741, data units 102 are categorized based on scene information 202, so as to form at least one scene domain. In Step 751, based on the subject knowledge base, for the image data 103 of each data unit in the scene domain, subject information 201 is identified from the image data 103 using an automatic image identification method, so as to obtain at least one subject domain corresponding to specific scene information. In Step 761, the elements in each subject domain are categorized based on specific subject information 201, so as to obtain a plurality of specific domains. The elements in each specific domain contain the same subject information 201 and the same scene information 202.

It should be noted that the method in the present embodiment may also be applied for identifying sentiment information from data, and for mining correlation between subject information and sentiment information.

### Embodiment 4

This embodiment is adjusted based on the method of Embodiment 2.

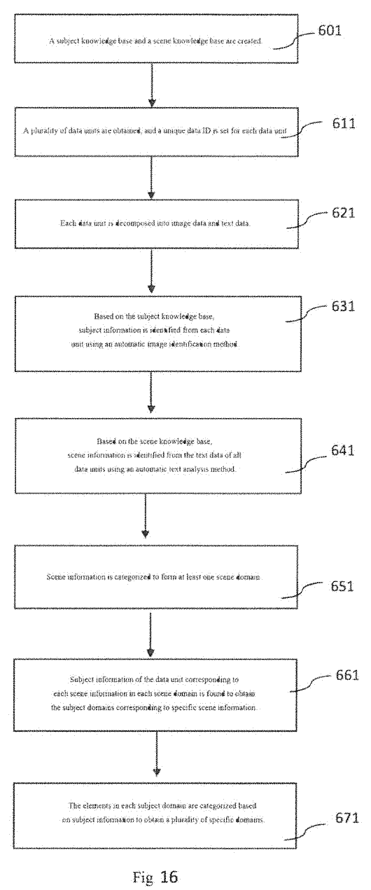

As shown in FIG. 16, Steps 601-641 of the data mining method in the present embodiment are identical to Steps 600-640 of Embodiment 2. The difference lies in that, in Embodiment 2, subject information 201 is categorized first, then a corresponding scene information 202 is associated to the subject information 201, and then the scene information 202 is categorized so as to obtain specific domains. However, in the present embodiment, scene information 202 is categorized first, then a corresponding subject information 201 is associated to the scene information 202, and then the subject information 201 is categorized so as to obtain specific domains.

Specifically, in Step 651, scene information 202 is categorized so as to form at least one scene domain. In Step 661, subject information 201 of the data unit corresponding to each scene information 202 in each scene domain may be found, thereby obtaining the subject domains corresponding to specific scene information. In Step 671, the elements in each subject domain are categorized based on subject information 201, so as to obtain a plurality of specific domains. The elements in each specific domain contain the same subject information 201 and the same scene information 202.

It should be noted that the method in the present embodiment may also be applied for identifying sentiment information from data, and for mining correlation between subject information and sentiment information.

The technical features in the embodiments described above may be combined arbitrarily. The foregoing are embodiments and figures of the present invention. However, the above embodiments and figures are not intended to limit the scope of the present invention. Any implementation carried out using the same technical means or within the scope of the following claims does not depart from the scope of the present invention.

1. A data mining method for mining mixed-type data including image data and text data, wherein said image data contains subject information and said text data contains scene information or sentiment information, said data mining method being characterized in comprising the following steps:
a. creating a subject knowledge base, and creating a scene knowledge base or sentiment knowledge base;
b. obtaining a plurality of data units, wherein at least a number of said data units comprise image data and text data, wherein said image data contains subject information and said text data contains scene information or sentiment information;
c. decomposing each of said data units into image data and text data;
d. based on said subject knowledge base, for the image data of each data unit, identifying the subject information from the image data using an automatic image identification method;
e. categorizing data units based on subject information, so as to form at least one subject domain, wherein each of said subject domain corresponds to a plurality of data units;
f. based on said scene knowledge base or sentiment knowledge base, for the text data of each data unit in each subject domain, identifying the scene information or sentiment information from the text data using an automated text analysis method, so as to obtain at least one scene domain or sentiment domain corresponding to specific subject information; and
g. categorizing the data units in each scene domain or sentiment domain based on scene information or sentiment information, so as to obtain a plurality of specific domains, wherein each of said specific domains contains the same subject information and the same scene information, or contains the same subject information and the same sentiment information.

2. The data mining method according to claim 1, wherein said data unit is provided with a data identifier, wherein image data and text data belonging to the same data unit have the same data identifier and are associated with each other via the data identifier.

3. The data mining method of claim 1, wherein said automatic image identification method comprises the following steps:
extracting identification features of an image data to be processed; and
inputting identification features of said image data into the subject knowledge base to perform computation, so as to determine whether specific subject information is contained.

4. The data mining method of claim 1, wherein said automatic text analysis method comprises the following steps:
extracting analysis features of a text data; and
inputting analysis features of said text data into the scene knowledge base or sentiment knowledge base to perform computation, so as to determine whether specific scene information or sentiment information is contained.

5. The data mining method of claim 1, wherein said automatic text analysis method comprises the following steps:
extracting keywords from a target text;
inputting the keywords into the scene knowledge base or sentiment knowledge base, and determine whether the target text contains the specific scene information or sentiment information based on syntactic rules.

6. The data mining method of claim 1, wherein said data mining method further comprises the following step:
h. ordering all the specific domains containing the same subject information according to the number of elements therein.

7. The data mining method of claim 1, wherein said data mining method further comprises the following step:
h. ordering all the specific domains containing the same scene information or sentiment information according to the number of elements therein.

8. The data mining method of claim 1, wherein said data mining method further comprises the following step:
h. filtering all the specific domains based on filtering criteria, and ordering the specific domains after filtering according to the number of elements therein.

9. A data mining method for mining mixed-type data, said data mining method being characterized in comprising the following steps:
a. creating a subject knowledge base, and creating a scene knowledge base or sentiment knowledge base;
b. obtaining a plurality of data units, wherein at least a number of said data units comprise image data and text data, wherein said image data contains subject information and said text data contains scene information or sentiment information;
c. decomposing each of said data units into image data and text data;
d. based on said subject knowledge base, for the image data of each data unit, identifying the subject information from the image data using an automatic image identification method;
e. based on said scene knowledge base or sentiment knowledge base, for the text data of each data unit, identifying the scene information or sentiment information from the text data using an automated text analysis method;
f. categorize data units based on subject information, so as to form at least one subject domain;
g. for each subject domain, finding the scene information or sentiment information of the data unit corresponding to each subject information, so as to obtain a scene domain or sentiment domain corresponding to specific subject information; and
h. categorizing elements in each of said scene domain or sentiment domain based on scene information or sentiment information, so as to obtain a plurality of specific domains, wherein each of said specific domains contains the same subject information and the same scene information, or contains the same subject information and the same sentiment information.

10. A data mining method for mining mixed-type data including image data and text data, wherein said image data contains subject information and said text data contains scene information or sentiment information, said data mining method being characterized in comprising the following steps:
a. creating a subject knowledge base, and creating a scene knowledge base or sentiment knowledge base;
b. obtaining a plurality of data units, wherein at least a number of said data units comprise image data and text data, wherein said image data contains subject information and said text data contains scene information or sentiment information;
c. decomposing each of said data units into image data and text data;
d. based on said scene knowledge base or sentiment knowledge base, for the text data of each data unit, identifying the scene information or sentiment information from the text data using an automated text analysis method;
e. categorizing data units based on scene information or sentiment information, so as to form at least one scene domain or sentiment domain, wherein each of said scene domain or sentiment domain corresponds to a plurality of data units;
f. based on said subject knowledge base, for the image data of each data unit in each scene domain or sentiment domain, identifying the subject information from the image data using an automated image identification method, so as to obtain at least one subject domain corresponding to specific scene information or sentiment information; and
g. categorizing the elements in each of said subject domain based on subject information, so as to obtain a plurality of specific domains, wherein each of said specific domains contains the same subject information and the same scene information, or contains the same subject information and the same sentiment information.

11. A data mining method for mining mixed-type data, said data mining method being characterized in comprising the following steps:
a. creating a subject knowledge base, and creating a scene knowledge base or sentiment knowledge base;
b. obtaining a plurality of data units, wherein at least a number of said data units comprise image data and text data, wherein said image data contains subject information and said text data contains scene information or sentiment information;
c. decomposing each of said data units into image data and text data;
d. based on said subject knowledge base, for the image data of each data unit, identifying the subject information from the image data using an automatic image identification method;
e. based on said scene knowledge base or sentiment knowledge base, for the text data of each data unit, identifying the scene information or sentiment information from the text data using an automated text analysis method;
f. categorizing the scene information or sentiment information, so as to form at least one scene domain or sentiment domain;
g. for each scene domain or sentiment domain, finding the subject information of the data unit corresponding to each scene information or sentiment information, so as to obtain a subject domain corresponding to specific scene information or sentiment information; and
h. categorizing elements in each of said subject domain based on subject information, so as to obtain a plurality of specific domains, wherein each of said specific domains contains the same subject information and the same scene information, or contains the same subject information and the same sentiment information.
